(19) United States
(12) Patent Application Publication
(10) Pub. No.: US 2009/0031180 A1
(43) Pub. Date: Jan. 29, 2009

(54) Method for Discovering and Isolating Failure of High Speed Traces in a Manufacturing Environment

(75) Inventors: Brian James Cagno, Tucson, AZ (US); Gregg Steven Lucas, Tucson, AZ (US); Thomas Stanley Truman, Tucson, AZ (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: IBM Corporation

(21) Appl. No.: 11/828,649

(22) Filed: Jul. 26, 2007

(51) Int. Cl. G06F 11/07

(52) U.S. Cl. 714/732; 714/E11.002

(57) ABSTRACT

A mechanism is provided for discovering and isolating failure of high speed traces in a manufacturing environment. The mechanism utilizes transmit pre-emphasis and receiver equalization in combination with attenuated wrap plugs to enhance discovery and isolation of manufacturing defects in the manufacturing environment. The mechanism adjusts pre-emphasis and equalization in real time in high speed devices, allowing for much greater variation to compensate for design margins and specification variances. While the card is under test with wrap-backs installed, the pre-emphasis and receiver equalization are brought to the limits while logging the bit error rate to a non-volatile memory element. The mechanism then compares the bit error rate information to empirically derived signatures for failure isolation.

### BACKGROUND

1. Technical Field

The present application relates generally to an improved data processing system and method. More specifically, the present application is directed to a method for discovering and isolating failure of high speed traces in a manufacturing environment.

2. Description of Related Art

Over the past decade, a transition has taken place as to the preferred method for implementing high throughput data links. Traditionally, high speed interfaces over relatively short distances were implemented using wide parallel buses, such as peripheral component interface extended (PCI-X), which contains a 64-bit wide data bus. More recent implementations use high speed serial links, such as Fibre Channel or serial attached SCSI (SAS), which usually only contain two bidirectional differential high speed pairs. In order to get the same data throughput as the wide parallel buses over a serial interface, the speed at which the data is transferred is dramatically increased, with recent speeds for Fibre Channel reaching 8 GHz and SAS reaching 6 GHz. This increase in speed presents vastly different challenges for testing in a manufacturing environment as compared to the wide parallel buses, which may only run at 133 MHz, as an example.

The typical measurement for determining if a high speed differential serial interface is acceptable is bit error rate (BER). Allowable limits for BER may be one error in 10¹² data bits. Most system designs have margin designed into them that greatly surpass the 1×10⁻¹² BER, which makes testing too long to be feasible for the manufacturing environment. Existing methods simply employ wrap back testing with attenuators to reduce the designed-in margin. The problem with this methodology is that it does not allow for component variation.

As an example, a typical serializer/de-serializer (SERDES) transmitter may be specified to have a maximum differential output of 1.0 V, while the minimum is specified for 600 mV. A typical SERDES receiver may be specified to have a minimum input amplitude of 200 mV. With these example numbers, an attenuator may be set to have a 12 dB attenuation, which would roughly reduce the transmitter amplitude by three. For a “worst case” transmitter of 600 mV, the signal would be reduced to 200 mV so that any manufacturing defects can easily be discovered and isolated. Any smaller defects in trace, solder quality, or components, such as blocking capacitors, will reduce the signal below the minimum value. However, a more typical or even a “best case” transmitter may still have enough margin on the signal so that manufacturing defects are not easily spotted leading to latent field failure.

As a specific example, a card may pass manufacturing tests with a solder short on a connector grounded half of a differential pair, essentially reducing the output amplitude by a factor of two. There may be enough margin still in the transmitter such that even after running in single ended mode and being attenuated by 12 dB in the manufacturing environment, no error is detected. At some time much later in the life of the card, a failure may be caused by the short in a customer environment.

### SUMMARY

The illustrative embodiments recognize the disadvantages of the prior art and provide a mechanism for discovering and isolating failure of high speed traces in a manufacturing environment. The mechanism utilizes transmit pre-emphasis and receiver equalization in combination with attenuated wrap plugs to enhance discovery and isolation of manufacturing defects in the manufacturing environment. The mechanism adjusts pre-emphasis and equalization in real time in high speed devices, allowing for much greater variation to compensate for design margins and specification variances. While the card is under test with wrap-backs installed, the pre-emphasis and receiver equalization are brought to the limits while logging the bit error rate to a non-volatile memory element. The mechanism then compares the bit error rate information to empirically derived signatures for failure isolation.

In one illustrative embodiment, a computer program product comprises a computer useable medium having a computer readable program. The computer readable program, when executed on a computing device, causes the computing device to create one or more signatures for devices with known hard error injects. Each signature within the one or more signatures comprises combinations of settings and error rate information for each combination of settings. The computer readable program further causes the computing device to vary settings on a device under test to test the device under test with a plurality of combinations of settings, monitor error rate for the device under test, log each combination of settings with corresponding error rate information, compare the logged combinations of settings and error rate information with the one or more signatures, and identify a faulty component or circuit based on the comparison.

In one exemplary embodiment, creating one or more signatures for devices with known hard error injects comprises varying settings on the given device to test the given device with a plurality of combinations of settings. The given device has a given hard error injected therein. Creating one or more signatures further comprises monitoring error rate for the given device, logging each combination of settings with corresponding error rate information for the given device, and storing the combination of setting and corresponding error rate information as a signature for the given hard error.

In a further exemplary embodiment, the settings on the given device comprise transmit pre-emphasis. In a still further exemplary embodiment, the settings on the given device comprise receiver equalization. In another exemplary embodiment, the error rate information comprises a measured bit error rate.

In one exemplary embodiment, the settings on the device under test comprise transmit pre-emphasis. In another exemplary embodiment, the settings on the device under test comprise receiver equalization. In a still further exemplary embodiment, the error rate information comprises a measured bit error rate.

In another illustrative embodiment, a data processing system comprises a processor and a memory coupled to the processor. The memory contains instructions which, when executed by the processor, cause the processor to create one or more signatures for devices with known hard error injects. Each signature within the one or more signatures comprises combinations of settings and error rate information for each combination of settings. The instructions further cause the processor to vary settings on a device under test to test the device under test with a plurality of combinations of settings, monitor error rate for the device under test, log each combination of settings with corresponding error rate information, compare the logged combinations of settings and error rate information with the one or more signatures, and identify a faulty component or circuit based on the comparison.

In one exemplary embodiment, creating one or more signatures for devices with known hard error injects comprises varying settings on the given device to test the given device with a plurality of combinations of settings. The given device has a given hard error injected therein. Creating one or more signatures further comprises monitoring error rate for the given device, logging each combination of settings with corresponding error rate information for the given device, and storing the combination of setting and corresponding error rate information as a signature for the given hard error.

In a further exemplary embodiment, the settings on the given device comprise transmit pre-emphasis. In a still further exemplary embodiment, the settings on the given device comprise receiver equalization.

In another exemplary embodiment, the settings on the device under test comprise transmit pre-emphasis. In yet another exemplary embodiment, the settings on the device under test comprise receiver equalization. In still another exemplary embodiment, the error rate information comprises a measured bit error rate.

In a further illustrative embodiment, a method for detecting and isolating a failure in a high speed device comprises creating one or more signatures for devices with known hard error injects. Each signature within the one or more signatures comprises combinations of settings and error rate information for each combination of settings. The method further comprises varying settings on a device under test to test the device under test with a plurality of combinations of settings, monitoring error rate for the device under test, logging each combination of settings with corresponding error rate information, comparing the logged combinations of settings and error rate information with the one or more signatures, and identifying a faulty component or circuit based on the comparison.

In one exemplary embodiment, creating one or more signatures for devices with known hard error injects comprises injecting a given hard error into a given device, varying settings on the given device to test the device under test with a plurality of combinations of settings, monitoring error rate for the given device, logging each combination of settings with corresponding error rate information for the given device, and storing the combination of setting and corresponding error rate information as a signature for the given hard error.

In another exemplary embodiment, the settings comprise transmit pre-emphasis. In yet another exemplary embodiment, the settings comprise receiver equalization. In still another exemplary embodiment, the error rate information comprises a measured bit error rate.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIGS. 1A-1C are block diagrams of a narrow port in a storage network in accordance with one illustrative embodiment;

FIGS. 2A-2C are block diagrams of a wide port in a storage network in accordance with one illustrative embodiment;

FIG. 3 is a block diagram illustrating a mechanism for creating failure signatures in accordance with an illustrative embodiment;

FIG. 4 is a block diagram illustrating a mechanism for detecting and isolating failure in high speed traces in accordance with an illustrative embodiment;

FIG. 5 is a flowchart illustrating operation of a mechanism for creating failure signatures in accordance with an illustrative embodiment; and

FIG. 6 is a flowchart illustrating operation of a mechanism for detecting and isolating failures in high speed devices in accordance with an illustrative embodiment.

### DETAILED DESCRIPTION OF THE ILLUSTRATIVE EMBODIMENTS

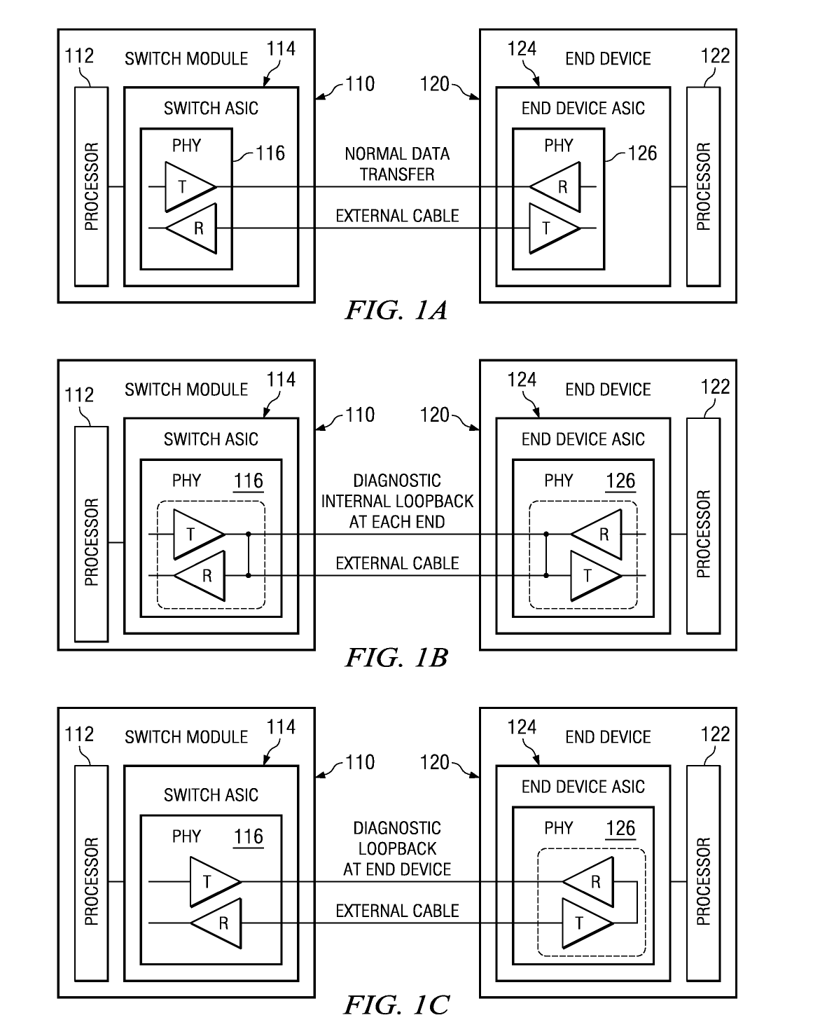

Referring to the figures, FIGS. 1A-1C are block diagrams of a narrow port in a storage network in accordance with one illustrative embodiment. More particularly with reference to FIG. 1A, switch module 110 has processor 112 and switch application specific integrated circuit (ASIC) 114. Switch ASIC has physical transceiver element (PHY) 116. A PHY includes a transmitter and receiver pair. End device 120 has processor 122 and end device ASIC 124. End device ASIC 124 has PHY 126. PHY 116 is connected to PHY 126 via an external cable for normal data transfer. In one exemplary embodiment, switch module 110 may be a serial attached SCSI (SAS) switch module and end device 120 may be a SAS end device.

With reference now to FIG. 1B, PHY 116 in switch ASIC 114 and PHY 126 in end device ASIC 124 are configured for diagnostic internal loopback at each end. In accordance with the illustrative embodiment, PHY 116 and PHY 126 have the capability to connect the transmitter to the receiver to form an internal loopback. FIG. 1B illustrates how the SAS network is configured during diagnostic verification of the external interface. The SAS devices at each end of the cabled interface perform an internal wrap to test out the narrow port of each respective device.

Turning to FIG. 1C, PHY 126 in end device ASIC 124 is configured for diagnostic loopback at the end device. PHY 126 has the capability to connect the transmitter to the receiver to form an external loopback. FIGS. 1A-1C illustrate configurations that provide the basis for failure isolation mechanism and procedure for narrow port to be described in further detail below. For example, the mechanism may attempt to isolate failures in PHY 116.

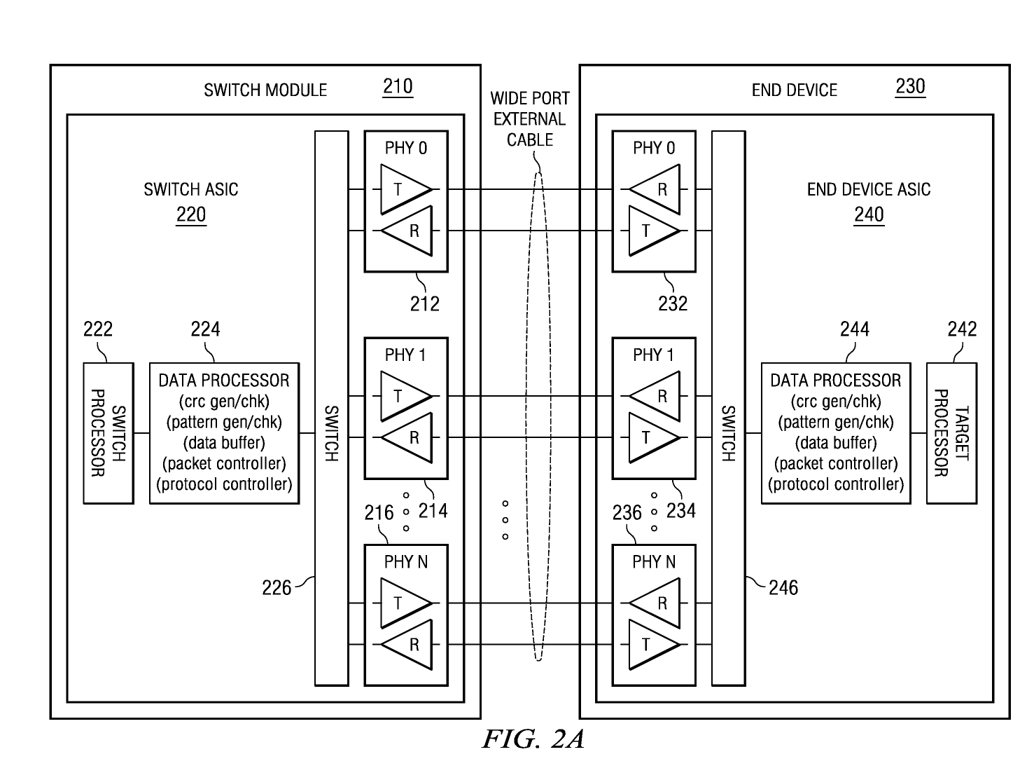

FIGS. 2A-2C are block diagrams of a wide port in a storage network in accordance with one illustrative embodiment. More particularly with reference to FIG. 2A, switch module 210 includes switch ASIC 220, which has switch processor 222, data processor 224, switch 226, and PHYs 0-N 212-216. Each PHY includes a transmitter and receiver pair. End device 230 includes end device ASIC 240, which has target processor 242, data processor 244, switch 246, and PHYs 0-N 232-236. PHYs 212-216 are connected to respective ones of PHYs 232-236 via a wide port external cable for normal data transfer. In one exemplary embodiment, switch module 210 may be a serial attached SCSI (SAS) switch module and end device 230 may be a SAS end device.

With reference now to FIG. 2B, PHYs 212-216 in switch ASIC 220 and PHYs 232-236 in end device ASIC 240 are configured for diagnostic internal loopback at each end. In accordance with the illustrative embodiment, PHYs 212-216 and PHYs 232-236 have the capability to connect the transmitter to the receiver to form an internal loopback. FIG. 2B illustrates how the wide port SAS network is configured during diagnostic verification of the external interface. The SAS devices at each end of the cabled interface perform an internal wrap to test out the narrow port of each respective device.

Turning to FIG. 2C, PHY 212 in switch ASIC 220 and PHY 232 in end device ASIC 240 are configured for normal data transfer. In the depicted example, PHY 0 212 is a command PHY. PHYs 1-N 234-236 in end device ASIC 240 are configured for diagnostic loopback at the end device. FIGS. 2A-2C illustrate configurations that may provide the basis for the failure isolation mechanism and procedure for wide port of the illustrative embodiments to be described in further detail below. For example, the mechanism may isolate failures in PHYs 234-236.

Those of ordinary skill in the art will appreciate that the hardware depicted in FIGS. 1A-1C and FIGS. 2A-2C may vary. For example, switch module 110 in FIGS. 1A-1C may include more than one narrow port, and switch module 210 in FIGS. 2A-2C may include more than one wide port. Other modifications to the storage area network configurations may be made within the spirit and scope of the present invention. The depicted examples are not meant to state or imply any architectural limitations with respect to the present invention.

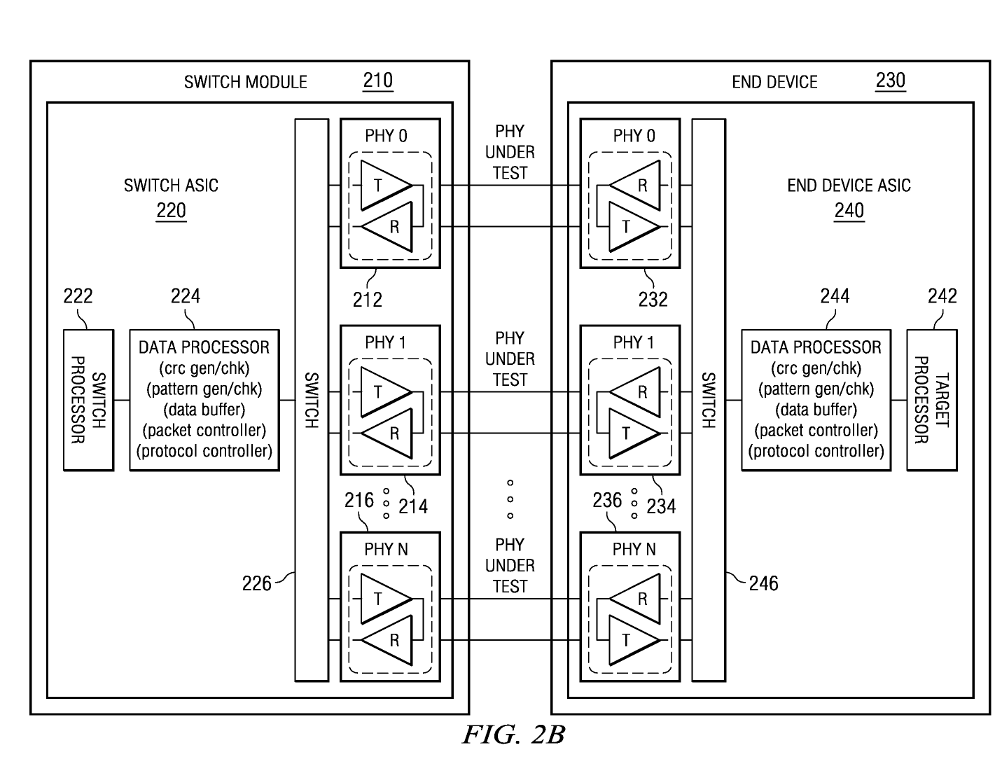

In accordance with an illustrative embodiment, various hard errors may be injected into a card, such as a switch module. FIG. 3 is a block diagram illustrating a mechanism for creating failure signatures in accordance with an illustrative embodiment. This may be performed in a lab environment or manufacturing environment. A tester injects hard errors into devices 302. When devices 302 are placed into test fixture 310, the mechanism logs the bit error rate (BER) for each different combination of pre-emphasis and receiver equalization and for each error inject. Test fixture 310 receives test patterns 312, which attempt to create data transfers that are likely to happen in the customer environment. The mechanism then stores the pre-emphasis and receiver equalization settings with BER for each error inject as signatures 314.

Test fixture 310 may include a processor, P, and a memory, M, for executing the test. Test fixture 310 may load instructions into the memory, M, for execution on the processor, P. These instructions may control the test of the devices with the hard errors injected therein and the devices under test. Furthermore, during monitoring, settings and the BER information may be stored in the memory, M.

For instance, a common manufacturing problem with high speed interfaces is cold solder joints on the blocking capacitors that sit inline on the high speed traces. For this first step, a cold solder joint is created on one of the capacitors, and the card is plugged into the test fixture. The different combinations of pre-emphasis and equalizations are tested, and a signature for this type of failure is recorded. The results may be that a pre-emphasis of 12-14 and a receiver equalization of 2-5 might be the typical combination to catch cold solder joints, because higher pre-emphasis creates faster edge rates, which should pull out capacitor problems.

Another example of an error inject may be a printed circuit board (PCB) defect that causes cross talk on high speed networks. Again, the error is injected, and combinations of pre-emphasis and equalization are tested. The mechanism stores a signature for this failure. The results should be that one transmit pair with maximum pre-emphasis, which creates no cross talk potential, and a different receiver pair with maximum equalization, which reduces signal to noise ratio, catches the failure. Other error injects may be solder shorts and trace imperfections, for example. The data logged in this step are used as signatures for detection and isolation in a real testing process.

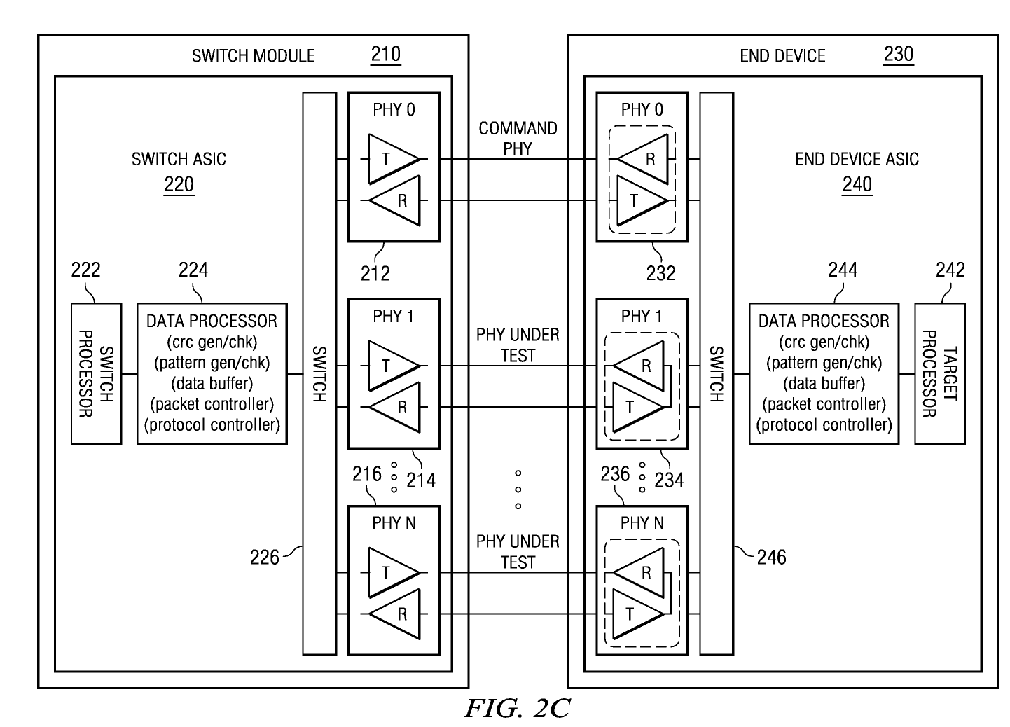

The next step is to test actual devices to discover and isolate failures in high speed traces in the manufacturing environment. FIG. 4 is a block diagram illustrating a mechanism for detecting and isolating failure in high speed traces in accordance with an illustrative embodiment. With each device under test 402 plugged into test fixture 410, the mechanism of the illustrative embodiments tests the pre-emphasis and equalization combinations and log error rates into a non-volatile memory, for example. Test fixture 410 receives test patterns 412, which attempt to create data transfers that are likely to happen in the customer environment. Test fixture 410 also receives signatures 414. Test fixture 410 then compares the recorded pre-emphasis and equalization combinations and bit error rates to signatures 414. If the BER for various combinations of pre-emphasis and receiver equalization match a signature for a known hard error, the failure is presented at failure isolation output 416, which may be a display, printout, or the like.

Test fixture 410 may include a processor, P, and a memory, M, for executing the test. Test fixture 410 may load instructions into the memory, M, for execution on the processor, P. These instructions may control the test of the devices with the hard errors injected therein and the devices under test. Furthermore, during monitoring, settings and the BER information may be stored in the memory, M.

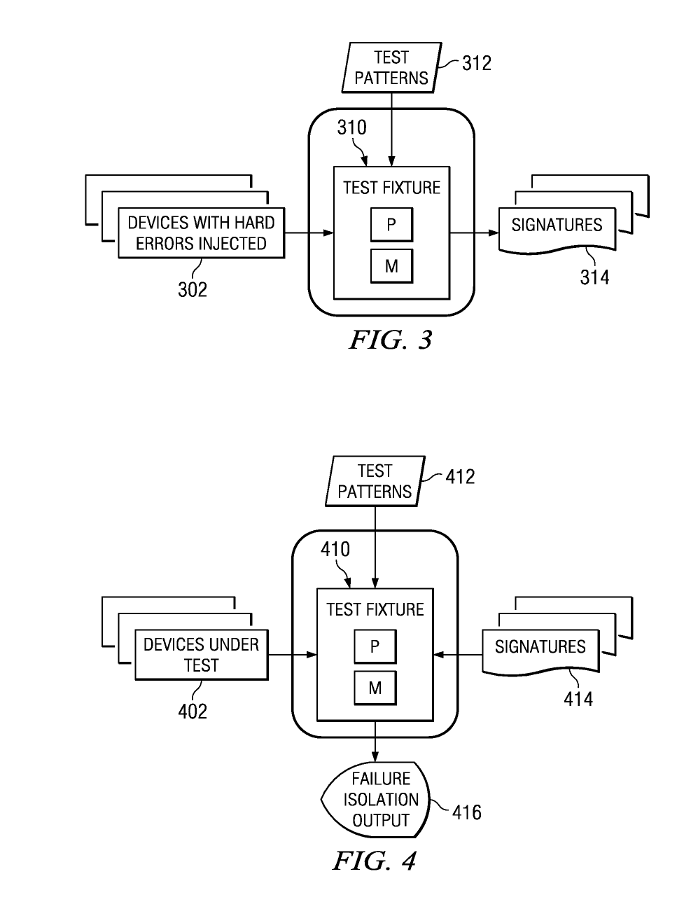

FIG. 5 is a flowchart illustrating operation of a mechanism for creating failure signatures in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

Furthermore, the flowcharts are provided to demonstrate the operations performed within the illustrative embodiments. The flowcharts are not meant to state or imply limitations with regard to the specific operations or, more particularly, the order of the operations. The operations of the flowcharts may be modified to suit a particular implementation without departing from the spirit and scope of the present invention.

With reference now to FIG. 5, operation begins and a tester injects a hard error into a device (block 502). The hard error may be a cold solder joint on a blocking capacitor, a printed circuit board defect that causes cross talk, a solder short, or a trace imperfection, for example. The tester varies pre-emphasis and receiver equalization on the device (block 504) and monitors errors and records a bit error rate (BER) for the device (block 506). The tester then logs the pre-emphasis and equalization settings and the error rate information (block 508).

Then, the tester determines whether more combination of pre-emphasis and receiver equalization settings remain to be tested (block 510). If more combinations remain, operation returns to block 504 to vary pre-emphasis and equalization settings. If no more combinations of pre-emphasis and equalization settings remain to be tested in block 510, the tester stores the settings and error rate information as a signature for the hard error (block 512).

Thereafter, the tester determines whether more hard error types are to be tested (block 514). If more hard error types remain to be tested, operation returns to block 502 where the tester injects a hard error into a device and operation repeats for the new hard error. If there are no more hard error types to test in block 514, operation ends.

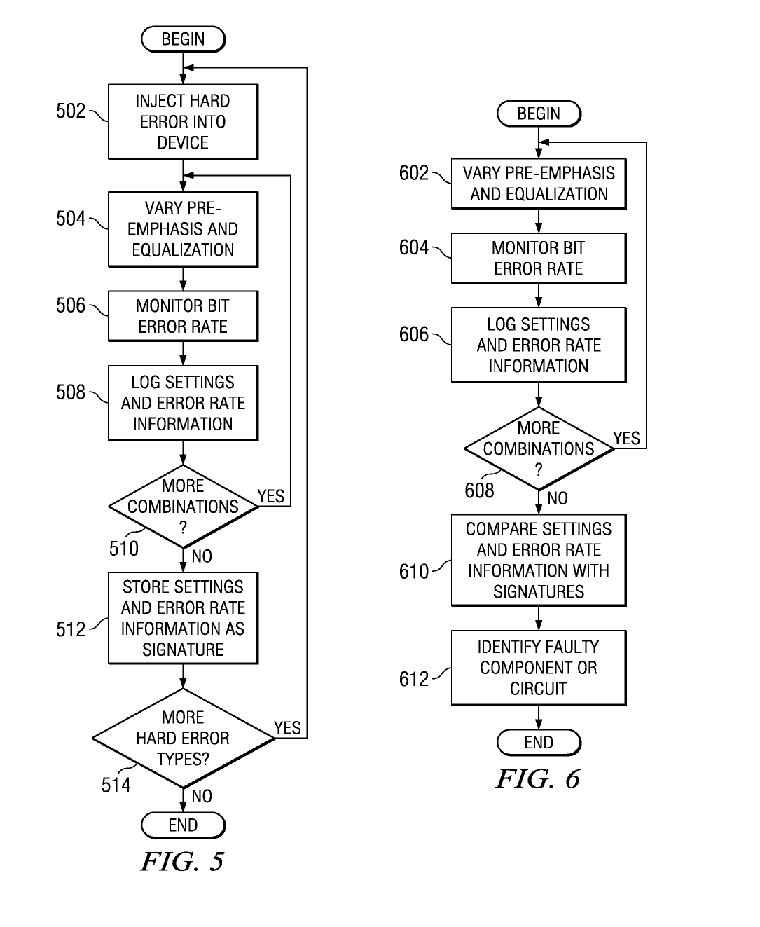

FIG. 6 is a flowchart illustrating operation of a mechanism for detecting and isolating failures in high speed devices in accordance with an illustrative embodiment. Operation begins, and the tester varies pre-emphasis and receiver equalization on the device (block 602) and monitors errors and records a bit error rate (BER) for the device (block 604). The tester then logs the pre-emphasis and equalization settings and the error rate information (block 606).

Then, the tester determines whether more combination of pre-emphasis and receiver equalization settings remain to be tested (block 608). If more combinations remain, operation returns to block 602 to vary pre-emphasis and equalization settings. If no more combinations of pre-emphasis and equalization settings remain to be tested in block 608, the tester compares the settings and error rate information with signatures for known failures (block 610). If the settings and error rate information reasonably matches with a signature for a known failure, the tester identifies the faulty component or circuit within the device under test (block 612). Thereafter, operation ends.

Thus, the illustrative embodiments solve the disadvantages of the prior art by providing a mechanism for discovering and isolating failure of high speed traces in a manufacturing environment. The mechanism utilizes transmit pre-emphasis and receiver equalization in combination with attenuated wrap plugs to enhance discovery and isolation of manufacturing defects in the manufacturing environment. The mechanism adjusts pre-emphasis and equalization in real time in high speed devices, allowing for much greater variation to compensate for design margins and specification variances. While the card is under test with wrap-backs installed, the pre-emphasis and receiver equalization are brought to the limits while logging the bit error rate to a non-volatile memory element. The mechanism then compares the bit error rate information to empirically derived signatures for failure isolation.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read-only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising a computer useable medium having a computer readable program, wherein the computer readable program, when executed on a computing device, causes the computing device to:
create one or more signatures for devices with known hard error injects, wherein each signature within the one or more signatures comprises combinations of settings and error rate information for each combination of settings;
vary settings on a device under test to test the device under test with a plurality of combinations of settings;
monitor error rate for the device under test;
log each combination of settings with corresponding error rate information;
compare the logged combinations of settings and error rate information with the one or more signatures; and
identify a faulty component or circuit based on the comparison.

2. The computer program product of claim 1, wherein creating one or more signatures for devices with known hard error injects comprises:
varying settings on a given device to test the given device with a plurality of combinations of settings, wherein the given device has a given hard error injected therein;
monitoring error rate for the given device;
logging each combination of settings with corresponding error rate information for the given device; and
storing the combination of setting and corresponding error rate information as a signature for the given hard error.

3. The computer program product of claim 2, wherein the settings on the given device comprise transmit pre-emphasis.

4. The computer program product of claim 2, wherein the settings on the given device comprise receiver equalization.

5. The computer program product of claim 2, wherein the error rate information comprises a measured bit error rate.

6. The computer program product of claim 1, wherein the settings on the device under test comprise transmit pre-emphasis.

7. The computer program product of claim 1, wherein the settings on the device under test comprise receiver equalization.

8. The computer program product of claim 1, wherein the error rate information comprises a measured bit error rate.

9. A data processing system, comprising:
a processor; and
a memory coupled to the processor, wherein the memory contains instructions which, when executed by the processor, cause the processor to:
create one or more signatures for devices with known hard error injects, wherein each signature within the one or more signatures comprises combinations of settings and error rate information for each combination of settings;
vary settings on a device under test to test the device under test with a plurality of combinations of settings;
monitor error rate for the device under test;
log each combination of settings with corresponding error rate information;
compare the logged combinations of settings and error rate information with the one or more signatures; and
identify a faulty component or circuit based on the comparison.

10. The data processing system of claim 9, wherein creating one or more signatures for devices with known hard error injects comprises:
varying settings on the given device to test the given device with a plurality of combinations of settings, wherein the given device has a given hard error injected therein;
monitoring error rate for the given device;
logging each combination of settings with corresponding error rate information for the given device; and
storing the combination of setting and corresponding error rate information as a signature for the given hard error.

11. The data processing system of claim 10, wherein the settings on the given device comprise transmit pre-emphasis.

12. The data processing system of claim 10, wherein the settings on the given device comprise receiver equalization.

13. The data processing system of claim 9, wherein the settings on the device under test comprise transmit pre-emphasis.

14. The data processing system of claim 9, wherein the settings on the device under test comprise receiver equalization.

15. The data processing system of claim 9, wherein the error rate information comprises a measured bit error rate.

16. A method for detecting and isolating a failure in a high speed device, the method comprising:
creating one or more signatures for devices with known hard error injects, wherein each signature within the one or more signatures comprises combinations of settings and error rate information for each combination of settings;
varying settings on a device under test to test the device under test with a plurality of combinations of settings;
monitoring error rate for the device under test;
logging each combination of settings with corresponding error rate information;
comparing the logged combinations of settings and error rate information with the one or more signatures; and
identifying a faulty component or circuit based on the comparison.

17. The method of claim 16, wherein creating one or more signatures for devices with known hard error injects comprises:
injecting a given hard error into a given device;
varying settings on the given device to test the device under test with a plurality of combinations of settings;
monitoring error rate for the given device;
logging each combination of settings with corresponding error rate information for the given device; and
storing the combination of setting and corresponding error rate information as a signature for the given hard error.

18. The method of claim 16, wherein the settings comprise transmit pre-emphasis.

19. The method of claim 16, wherein the settings comprise receiver equalization.

20. The method of claim 16, wherein the error rate information comprises a measured bit error rate.
